(19) United States
(12) Patent Application Publication
(10) Pub. No.: US 2019/0368788 A1
(43) Pub. Date: Dec. 5, 2019

(54) NOISE PREVENTING/REDUCING STRUCTURE AND METHOD FOR A REFRIGERATOR

(71) Applicant: Daewoo Electronics Co., Ltd., Gwangju (KR)

(72) Inventor: Key-Hwan HWANG, Incheon (KR)

(21) Appl. No.: 16/212,519

(22) Filed: Dec. 6, 2018

(30) Foreign Application Priority Data
May 29, 2018 (KR) 10-2018-0060982

(51) Int. Cl. F25B 41/00; F25D 23/00

(52) U.S. Cl. CPC F25B 41/003; F16L 55/0335; F25D 23/006

(57) ABSTRACT

The present disclosure relates to a structure and method of reducing refrigerator noise incident to a compressor failure. More particularly, the present disclosure relates to a structure and method of reducing refrigerator noise which is likely to occur due to collision of pipes or the like with surrounding structures when a compressor installed inside a refrigerator machine room stops operating. The noise preventing/reducing structure includes a support member protruding from a wall surface or a bottom surface of the refrigerator machine room and a protective member configured to surround at least a part of a pipe installed in the refrigerator machine room. The support member comprises: a cavity having one side open; a seating surface disposed in the cavity and configured to support the protective member seated thereon; and a raised portion protruding from the seating surface.

### CROSS REFERENCE TO RELATED APPLICATION

The present application claims priority to Korean Patent Application No. 10-2018-0060982, filed May 29, 2018, the entire contents of which is incorporated herein for all purposes by this reference.

### BACKGROUND OF THE INVENTION

### 1. Field of the Invention

The present disclosure relates to a structure and method of preventing/reducing noises from a refrigerator appliance. More particularly, the present disclosure relates to a structure and method of preventing/reducing refrigerator noise which is likely to occur incident to a compressor failure of a compressor of a refrigerator appliance.

### 2. Description of the Background Art

A refrigerator is an appliance for storing food items and maintaining them in a fresh state. For this purpose, in a refrigerator appliance, a refrigerant undergoes a refrigeration cycle including compression, condensation, expansion, and evaporation phases, thereby lowering the internal temperature of the refrigerator compartments.

Referring to FIG. 1, for implementation of the refrigeration cycle as described above, a refrigerator 1 includes a compressor 12 for compressing low-temperature and low-pressure phase refrigerant to high-temperature and high-pressure phase refrigerant and also includes a condenser 16 which allows the refrigerant passing through the compressor 12 to exchange heat with external air.

Generally, the compressor 12 and the condenser 16 devices are mounted inside a machine room 10 which can be disposed in a lower rear portion of the refrigerator appliance. The compressor 12 is installed at one side in the machine room 10 of the refrigerator 1, and the condenser 16, which typically emits a large amount of heat, is installed on the opposite side in the machine room 10. Further, a connection pipe 18 is provided between the compressor 12 and the condenser 16 so that the refrigerant can flow therebetween. On the side surface of the condenser 16, a blower 14 is installed for cooling the machine room 10 through forced air convection, thereby removing the heat generated in the machine room 10 and particularly the heat generated by the condenser 16.

During the operation of the refrigeration cycle, vibrations occur when the compressor 12 is stopped, whereby various pipes such as the connection pipe 18, and the like, (which are provided in the machine room 10) may rattle around in the machine room due to the vibrations. For instance, the pipes may come into contact with the wall surface 22 or the bottom surface 24 of the machine room 10, thereby generating noise. Furthermore, pipes connecting various parts are usually loosely installed and therefore rattle under vibration. Also, because the pipes are usually longer than the distance between the parts, it is difficult to prevent the pipes from coming into contact with the wall surface 22 or the bottom surface 24 under vibration.

Conventionally, a compressor mounting structure has been developed for solving these problems of vibration and noise which are generated when an active compressor continues to operate. However, a solution to the problem of contact noise caused by vibration when an active compressor is deactivated has not been sufficiently considered.

Therefore, it is necessary to devise a refrigerator appliance which can solve the above-mentioned problems.

### SUMMARY OF THE INVENTION

The present disclosure has been made to solve the problems occurring in the related art and an object of the present invention is to provide a noise preventing structure for a refrigerator appliance, the structure being capable of preventing/reducing contact noise generated between a pipe and a surrounding structure due to vibrations generated in a refrigerator machine room when a compressor of the refrigerator stops operating.

Another object of the present disclosure is to provide a noise preventing/reducing structure for a refrigerator appliance, the structure being capable of easily and effectively preventing contact noise attributable to vibration in a refrigerator machine room.

It is to be understood that the objects of the present disclosure are not limited to the above-mentioned ones, and other objects which are not mentioned above can be understood from the following description by those skilled in the art to which the present disclosure pertains.

The embodiments of the present disclosure for achieving the objects described above and for performing characteristic functions of the present disclosure are described as follows.

According to the present disclosure, a noise preventing/reducing structure for a refrigerator appliance includes a support member protruding inward from a wall surface (or a bottom surface) of a refrigerator machine room, and a protective member disposed in the support member and configured to surround at least a part of a pipe installed in the refrigerator machine room.

Preferably, the support member may be removably or integrally formed at a predetermined point on the wall surface (or the bottom surface) of the refrigerator machine room.

Preferably, the support member may include: a cavity having one side open; a seating surface disposed in the cavity and configured to receive the protective member thereon; and a raised portion provided on the seating surface.

The protective member may include a recess disposed in an outer circumferential surface, and where the recess has a complementary shape to the raised portion so that the recess can engage with the raised portion.

The protective member may include a first protective member made of a first material and configured to surround an outer circumferential surface of a portion of a pipe and may also include a second protective member made of a second material which is different from the first material and is further configured to surround an outer circumferential surface of the first protective member.

The second protective member may have a groove in an inner circumferential surface thereof, and where the groove has a complementary shape to an external shape of the first protective member.

The second protective member may include coupling portions at respective ends thereof, and where the coupling portions may engage with each other in a disengeable manner.

A refrigerator in accordance with an embodiment of the present invention comprises: a storage compartment for storing and maintaining fresh food items; a machine room comprising a compressor and a pipe installed within the machine room; and a noise reducing structure, the noise reducing structure comprising: a support member protruding from a wall surface or a bottom surface of the machine room; and a protective member seated in the support member and configured to surround at least a part of the pipe installed in the machine room.

Another embodiment pertains to a method of noise reduction in a refrigerator appliance. A noise preventing/reducing method for a refrigerator according to an embodiment of the present disclosure includes: detecting a contact point where a pipe installed in a refrigerator machine room collides with a part installed in the refrigerator machine room; installing a support member at the contact point; and mounting a protective member on a seating surface of the support member in such a manner to surround a portion of the pipe.

The support member may be removably installed, and the protective member may be provided with coupling portions at respective ends thereof so that the coupling portions can engage with each other in a disengeable manner.

Preferably, the support member may include: a cavity having one side open; a seating surface disposed in the cavity and configured to receive the protective member thereon; and a raised portion disposed on the seating surface.

Preferably, the protective member may include a recess disposed in an outer circumferential surface, in which the recess has a complementary shape to the raised portion so that the recess can engage with the raised portion.

According to the present disclosure, it is possible to provide a noise preventing/reducing structure for a refrigerator appliance, the structure being capable of preventing/reducing contact noise generated between a pipe and its surrounding structures rattling due to vibrations generated in a refrigerator machine room when a compressor of a refrigerator stops operating.

Further, according to the present disclosure, there is provided a noise preventing/reducing structure for a refrigerator appliance that can easily and effectively prevent/reduce contact noise due to vibration in a refrigerator machine room.

The effects of the present disclosure are not limited to those described above, and other effects not mentioned above also can be clearly recognized by those skilled in the art from the following description.

### BRIEF DESCRIPTION OF THE DRAWINGS

FIG. 1 illustrates a layout of an internal structure of a refrigerator machine room;

FIG. 2 illustrates a layout of an internal structure of a machine room in which a noise preventing/reducing structure is located for a refrigerator machine room according to the present disclosure;

FIG. 3 is an enlarged view of a support member illustrated in FIG. 2, according to one embodiment of the present disclosure;

FIG. 4A is a side view of the support member according to one embodiment of the present disclosure;

FIG. 4B is a top view of the support member according to one embodiment of the present disclosure;

FIG. 5A is a cross-sectional view of a pipe around which a protective member according to one embodiment of the present disclosure is provided;

FIG. 5B is a cross-sectional view taken along a line AA′ in FIG. 5A;

FIG. 6 illustrates a second protective member according to one embodiment of the present disclosure; and

FIGS. 7A and 7B are respectively a top view and a bottom view of the second protective member according to one embodiment of the present disclosure.

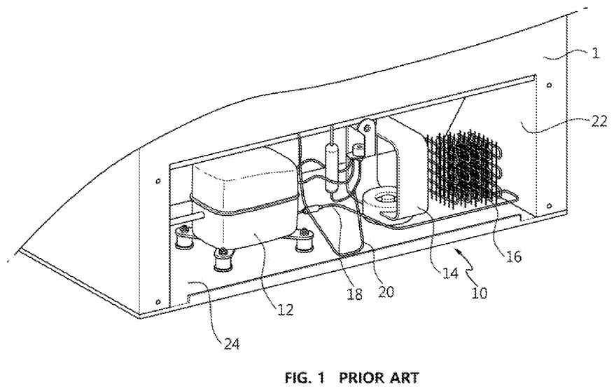

### DETAILED DESCRIPTION OF THE DISCLOSURE

In the following description, the specific structural or functional descriptions for exemplary embodiments according to the concept of the present disclosure are merely for illustrative purposes. So, those skilled in the art will appreciate that various modifications and changes to the exemplary embodiments are possible, without departing from the scope and spirit of the present disclosure. Therefore, the present disclosure is intended to cover not only the exemplary embodiments but also various alternatives, modifications, equivalents, and other embodiments that may be included within the spirit and scope of the embodiments as defined by the appended claims.

Terms used in the specification, “first”, “second”, etc. can be used to discriminate one component from another component, but the order or priority of the components are not limited by the terms unless specifically stated. Accordingly, a first component in an embodiment may be referred to as a second component in another embodiment, and similarly, a second component in an embodiment may be referred to as a first component in another embodiment, only for the purpose of discrimination of one component from another component, without departing from the scope of the present disclosure defined based on the concept of the present disclosure.

In the present disclosure, it will be understood that when a component is referred to as being “connected” or “coupled” to another component, one component can be directly connected or coupled to another component, or intervening components may be present therebetween. In contrast, it should be understood that when a component is referred to as being “directly connected” or “directly coupled” to another component, there are no intervening elements present between the components. Further, the terms used herein to describe a relationship between components, for example, “between”, “directly between”, “adjacent” or “directly adjacent” should be interpreted in the same manner as those described above.

Like reference numerals designate like elements throughout the specification. The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinbelow, exemplary embodiments of the present disclosure will be described in detail with reference to the accompanying drawings.

### Noise Preventing/Reducing Structure and Method for a Refrigerator

According to the present disclosure, a noise preventing/reducing structure for a refrigerator includes a support member protruding from a wall surface or a bottom surface of a refrigerator machine room and a protective member configured to surround at least a part of a pipe installed in the refrigerator machine room.

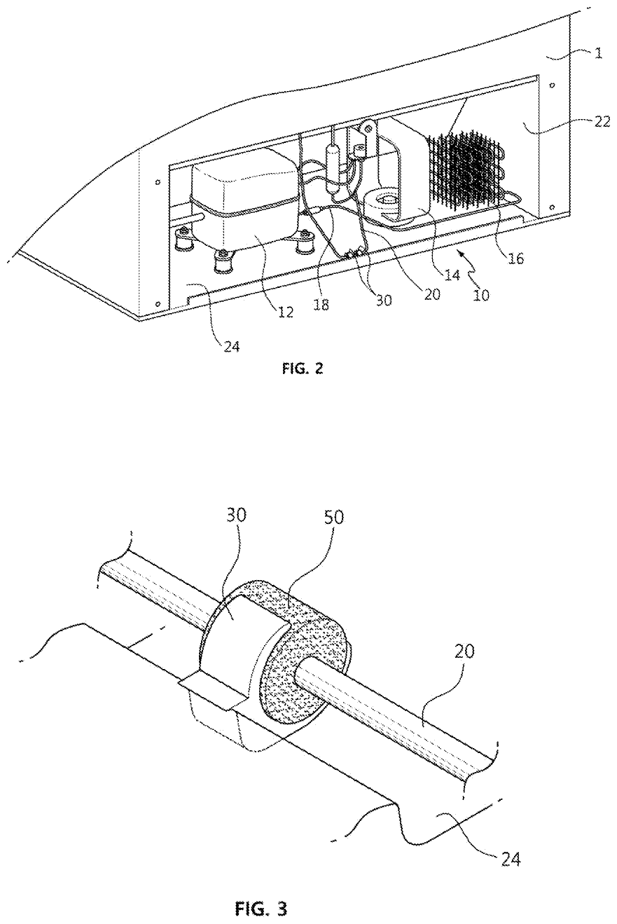

Referring to FIG. 2, the noise preventing/reducing structure for a refrigerator includes a support member 30 formed on a wall surface 22 or a bottom surface 24 of a machine room 10 of a refrigerator 1 in order to support various pipes 20 installed in the machine room 10. The support member 30 is provided at a point (e.g., boundary) where the wall surface 22 and the bottom surface 24 meets, or a point on the wall surface 22 or the bottom portion 24.

FIG. 3 is a partially enlarged view of FIG. 2, and illustrates the support member 30 disposed on one surface of the machine room 10 and a pipe 20 surrounded by a protective member 50. The support member 30 can be permanently affixed to the wall surface 22 or the bottom surface 24 as illustrated in FIG. 3. Alternatively, the support member 30 may be removably attached to the wall surface 22 or the bottom surface 24 as necessary. In the case of being removably attached, the support member 30 can be joined to the inside surface of the machine room 10 by any of a number of well known attaching means such as an adhesive.

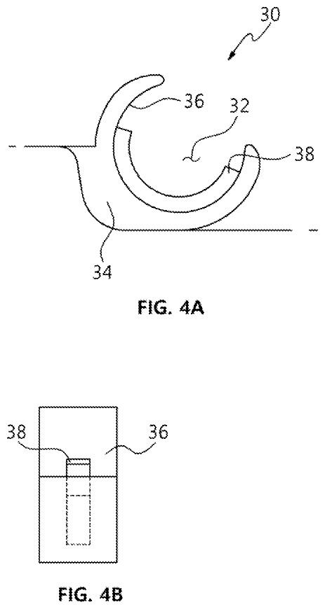

As illustrated in FIG. 4A, the support member 30 has a cavity 32 having one side open so that the protective member 50 can be inserted into the cavity and also removed through the opening. The support member 30 further has a seating surface 36 disposed in the cavity 32 and configured to receive the protective member 50 seated thereon, and a connecting portion 34 configured to connect the seating surface 36 to the wall surface 22 or the bottom surface 24.

In addition, according to one embodiment of the present disclosure, as illustrated in FIGS. 4A and 4B, the support member 30 further includes a raised portion 38 that protrudes from the seating surface 36. The raised portion 38 is a portion that makes the seating of the protective member 50 easier and more stable, which will be described later.

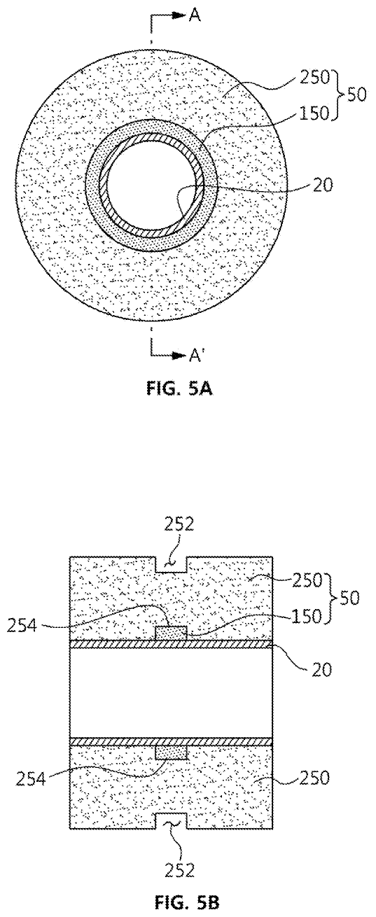

FIG. 5A illustrates a state in which the protective member 50 is attached to the pipe 20. The protective member 50 includes a first protective member 150 made of a first material and configured to surround the outer circumferential surface of a portion of the pipe 20 and also includes a second protective member 250 formed of a second material which is different from the first material and is further configured to surround the outer circumferential surface of the second protective member 250. For example, the first material may be an elastic material such as rubber, which can be used in tight contact with the surface of the pipe, and the second material may be a sponge type material made of polyurethane, polyethylene, or the like. Of course, other suitable materials can be used.

Referring to FIG. 5B, the second protective member 250 has a groove 254 that extends in an inner circumferential surface so that the first protective member 150 can be received in the groove 254. The first protective member 150 has a complementary shape to the groove 254 formed in the inner surface of the second protective member 250 so that the first protective member 150 can be seated in the groove 254. In this case, it is possible to prevent the second protective member 250 from moving relative to the first protective member 150, thereby making the coupling between the first protective member 150 and the second protective member 250 stable and firm.

The second protective member 250 has a recess 252 in the outer circumferential surface thereof. The recess 252 is formed in a manner of being recessed in a radial direction so as to accommodate the raised portion 38 of the support member 30. As described above, when the second protective member 250 is seated on the support member 30, the recess 252 of the second protective member 250 is engaged with the raised portion 38 of the support member 30. With this structure, it is possible to prevent the protective member 50 from being displaced from the support member 30 and ensures secure coupling between the protective member and the support member 30.

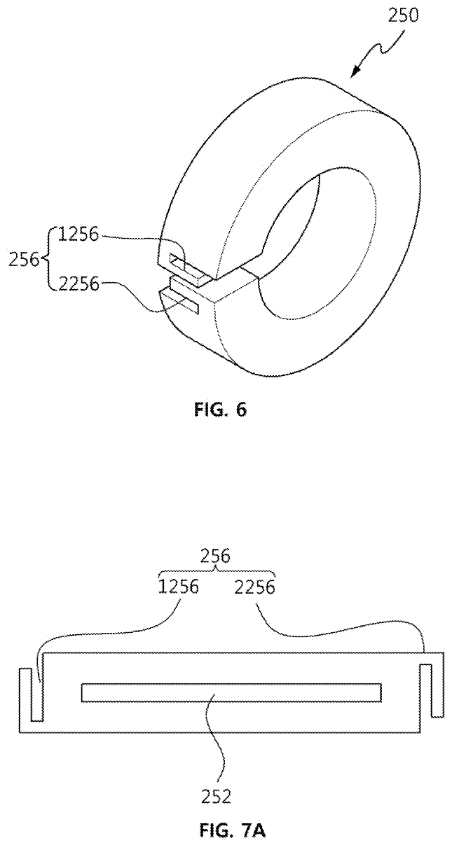

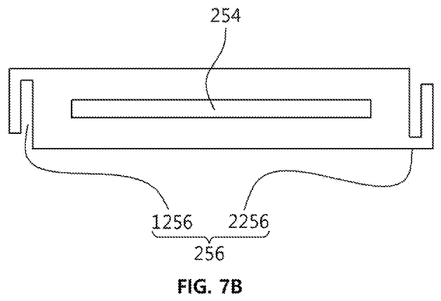

Referring to FIGS. 6, 7A and 7B, the second protective member 250 has coupling portions 256 formed at respective ends thereof so that the respective ends of the second protective member 250 can be engaged to form a ring shape and can be disengaged from each other to form a linear shape. The coupling portions 256 include a first coupling portion 1256 formed at one end of the second protective member 250 and a second coupling portion 2256 formed at the other end of the second protective member 250 to be engaged with the first coupling portion 1256. Due to the coupling portions 256, it is not necessary to mount the second protective member 250 in a longitudinal direction of the pipe 20. That is, the second protective member 250 can be mounted on the pipe 20 from a lateral side. Therefore, the coupling portions 256 facilitate mounting of the second protective member 250 on the pipe 20. Although only the coupling portions having a specific shape are illustrated in the drawing, the coupling portions are not limited thereto, and any suitable shape of coupling portions can be used as long as the coupling portions are shaped to connect one end to the other end of the protective member.

According to another embodiment of the present disclosure, a noise preventing/reducing method for a refrigerator is provided. The noise preventing/reducing method includes a step of detecting a contact point where contact between a pipe 20 installed in a machine room 10 of a refrigerator 1 and a machine room internal structure occurs when a compressor 12 is stopped.

In addition, the noise preventing/reducing method further includes a step of installing a support member 30 at the contact point. As illustrated in FIG. 4A, the support member 30 has a cavity 32 having one side open, a seating surface 36 disposed in the cavity 32 and configured to allow a protective member 50 to be seated thereon, and a connecting portion 34 configured to connect the seating surface 36 to a wall surface 22 (or a bottom surface 24) of the machine room 10.

In a case where the support member 30 is removably attached to the wall surface 22 (or the bottom surface 24), the support member 30 will be installed at the point where the contact between the pipe 20 and the internal structure is detected in the detecting step. In this case, it is not necessary to install a large number of support members in the machine room. That is, installation of the support members only at the detected contact points is required. Therefore, noise can be more effectively prevented/reduced. In this case, the support member 30 can be joined to the inner surface of the machine room 10 by any well known suitable attaching means such as an adhesive. In this case, since the support member 30 will be installed only at a point where the contact is likely to occur, contact noise can be more effectively prevented/reduced.

The method further includes a step of mounting a protective member 50, which is configured to surround at least a portion of the pipe 20, on the seating surface 36 of the support member 30. The protective member 50 includes a first protective member 150 made of a first material and configured to surround the outer circumferential surface of a portion of the pipe 20 and a second protective member 250 formed of a second material different from the first material and configured to surround the outer circumferential surface of the second protective member 250. The second protective member 250 includes coupling portions 256 which are formed at respective ends thereof and configured to be engaged and disengaged from each other. Therefore, the second protective member 250 can be mounted on the pipe 20 from a lateral side, which facilitates mounting of the protective member onto the pipe.

The support member 30 includes a raised portion 38 raised from the seating surface 36. The outer circumferential surface of the second protective member 250 is provided with a recess 252 recessed in a radial direction from the circumferential surface and configured to be complementary to the raised portion so as to accommodate the raised portion. Therefore, the support member 30 and the protective member 50 can be easily engaged with each other.

Although the preferred embodiments of the present disclosure have been disclosed for illustrative purposes, those skilled in the art will appreciate that various modifications, additions and substitutions are possible, without departing from the scope and spirit of the invention as disclosed in the accompanying claims.

What is claimed is:

1. A noise reducing structure for a refrigerator, the structure comprising:
a support member protruding from a wall surface or a bottom surface of a refrigerator machine room; and
a protective member seated in the support member and configured to surround at least a part of a pipe installed in the refrigerator machine room.

2. The structure according to claim 1, wherein the support member is removably provided at a predetermined point on the wall surface or the bottom surface of the refrigerator machine room and wherein further, the predetermined point is a location at which the surface makes physical contact with the pipe under vibration of the refrigerator.

3. The structure according to claim 1, wherein the support member is permanently provided at a predetermined point on the wall surface or the bottom surface of the refrigerator machine room and wherein further, the predetermined point is a location at which the surface makes physical contact with the pipe under vibration of the refrigerator.

4. The structure according to claim 1, wherein the support member comprises:
a cavity having one side open;
a seating surface disposed in the cavity and configured to support the protective member seated thereon; and
a raised portion raised from the seating surface.

5. The structure according to claim 4, wherein the protective member comprises a recess in an outer circumferential surface thereof, wherein the recess has a complementary shape to the raised portion and is operable to engage with the raised portion.

6. The structure according to claim 1, wherein the protective member comprises:
a first protective member of a first material and configured to surround an outer circumferential surface of a portion of a pipe; and
a second protective member of a second material different from the first material and configured to surround an outer circumferential surface of the first protective member.

7. The structure according to claim 6, wherein the second protective member comprises a groove in an inner circumferential surface thereof, wherein the groove has a complementary shape to an external shape of the first protective member.

8. The structure according to claim 6, wherein the second protective member comprises coupling portions at respective ends thereof, wherein the coupling portions are configured to selectively engage with each other and disengage from each other.

9. A refrigerator comprising:
a storage compartment for storing and maintaining fresh food items;
a machine room comprising a compressor and a pipe installed within the machine room; and
a noise reducing structure, the structure comprising:
a support member protruding from a wall surface or a bottom surface of the machine room; and
a protective member seated in the support member and configured to surround at least a part of the pipe installed in the machine room.

10. The refrigerator according to claim 9, wherein the support member is removably provided at a predetermined point on the wall surface or the bottom surface of the machine room and wherein further, the predetermined point is a location at which the surface makes physical contact with the pipe under vibration of the refrigerator.

11. The refrigerator according to claim 9, wherein the support member is permanently provided at a predetermined point on the wall surface or the bottom surface of the machine room and wherein further, the predetermined point is a location at which the surface makes physical contact with the pipe under vibration of the refrigerator.

12. The refrigerator according to claim 9, wherein the support member comprises:
a cavity having one side open;
a seating surface disposed in the cavity and configured to support the protective member seated thereon; and
a raised portion raised from the seating surface.

13. The refrigerator according to claim 12, wherein the protective member comprises a recess in an outer circumferential surface thereof, wherein the recess has a complementary shape to the raised portion and is operable to engage with the raised portion.

14. The refrigerator according to claim 9, wherein the protective member comprises:
a first protective member of a first material and configured to surround an outer circumferential surface of a portion of the pipe; and
a second protective member of a second material different from the first material and configured to surround an outer circumferential surface of the first protective member.

15. The refrigerator according to claim 14, wherein the second protective member comprises a groove in an inner circumferential surface thereof, wherein the groove has a complementary shape to an external shape of the first protective member.

16. The refrigerator according to claim 14, wherein the second protective member comprises coupling portions at respective ends thereof, wherein the coupling portions are configured to selectively engage with each other and disengage from each other.

17. A noise reducing method for a refrigerator machine, the method comprising:
detecting a contact point at which contact occurs between a pipe installed in a refrigerator machine room and a machine room internal structure;
installing a support member at the contact point; and
mounting a protective member configured to surround at least a portion of the pipe on a seating surface of the support member, and
wherein said support member is operable to reduce noise produced incident to vibration of the pipe upon a failure of a compressor located within the refrigerator machine room.

18. The method according to claim 17, wherein the support member is removably installed, and wherein further the protective member comprises coupling portions disposed at respective ends thereof and operable to be engaged with, and disengaged from, each other.

19. The method according to claim 18, wherein the support member comprises:
a cavity having one side open;
a seating surface disposed in the cavity and configured to support the protective member seated thereon; and
a raised portion protruding from the seating surface.

20. The method according to claim 19, wherein the protective member comprises a recess disposed in an outer circumferential surface, wherein the recess has a complementary shape to the raised portion wherein the recess engages with the raised portion.
